(19) United States
(12) Patent Application Publication
(10) Pub. No.: US 2019/0309511 A1
(43) Pub. Date: Oct. 10, 2019

(54) CARDBOARD FIRE RESISTANT WALL PANEL

(71) Applicant: CelluPlex B.V., Lemmer (NL)

(72) Inventor: Lode Maria BRUINS, Amsterdam (NL)

(21) Appl. No.: 16/315,387

(22) PCT Filed: May 18, 2017
(86) PCT No.: PCT/NL2017/050316

§ 371 Date: Jan. 4, 2019

(30) Foreign Application Priority Data
Jul. 6, 2016 (NL) 2017119
Dec. 16, 2016 (NL) 2018017

(51) Int. Cl. E04B 1/94; E04C 2/36; B32B 3/12

(52) U.S. Cl. CPC E04B 1/942; E04B 2001/748; B32B 3/12; E04C 2/365

(57) ABSTRACT

A fire delaying wall panel is provided that comprises a layer of cellular cardboard, comprising cell spaces surrounded by cardboard, the layer of cellular cardboard comprising a paper sheet on a first surface of the layer of cellular cardboard. Preferably, inert grains that are inert in fire, such as perlite and/or vermiculite grains are provided, in the cell spaces. A layer of fire resistant adhesive is provided on the paper sheet. A layer of iron or glass netting or a fiber mat is embedded in the layer of fire resistant adhesive, the fire resistant adhesive covering the paper sheet in mazes of the iron netting.

### FIELD OF THE INVENTION

The invention relates to a cardboard wall panel with fire resistant properties, and to a building wherein the structural component of the walls consist of such panels.

### BACKGROUND

Buildings with cardboard wall panels are known per se. For safety reasons, such wall panels should be able to resist fire for some time, to provide time for escape. For example, fire safety regulations for conventional buildings require that a wall should delay penetration of a fire at a temperature of 950 degrees Celsius by at least one hour. When the cardboard wall panels are used as structural elements, i.e. when they are indispensable to prevent the building from collapse, it must also be ensured that collapse of the building is delayed in the case of fire.

DE202011050486 U1 describes use of cardboard panels to hold isolation material on, or within structural walls is known from. In this context, the document mentions that that a honeycomb structure made of paper can be made fire proof by filling its spaces with mineral isolation material such as perlite, vermiculite etc., because the isolation material leaves no space for air to fuel fire.

US20010029718 discloses wall covering panels of fire resistant corrugated cardboard adhered to an aluminum layer. Panels of corrugated paper liner boards panels laminated with heat and fire proof adhesive materials are used, having a thin metallic foil adhered to its exterior surface.

However, in practice application of such fire prevention measures to cardboard walls may provide only limited time to escape once a fire develops flames and intense heat. Cardboard carbonizes at temperatures much lower than 950 degrees Celsius. When hot air flows of flames meet carbonized cardboard they can blow the cardboard and a filling of perlite or vermiculite grains away, with little penetration delay. An aluminum foil also fails to provide much penetration delay at high temperatures, because it melts at 660 degrees Celsius, well below the temperature of 950 degrees Celsius that a wall of a conventional building should be able to resist. The aluminum foil could be replaced by a sheet of metal with a higher melting temperature, such as iron (melts at 1583 degrees Celsius) e.g. in the form of steel, to ensure that the metal layer does not melt. But even then the metal layer deforms under heat already at lower temperature, with concomitant damage to the structural function of the cardboard layer(s).

### SUMMARY

It is an object to provide for a fire resistant cardboard wall panel, and to a building wherein the structural component of the walls consists of such panels, that provides for a longer time delay before heat due to fire compromises fire protection properties of the panel.

A wall panel is provided according to claim 1.

In this wall panel, the combination of the cardboard, the layer of fire resistant adhesive and the iron or glass netting, a glass netting or fiber mat combine to prevent rapid disintegration of the wall. The fiber mat may be a mat of chopped glass or carbon fibers or strands. A prefabricated mat may be used, or a mat made by depositing chopped glass or carbon fibers or strands. The layer of cellular cardboard may be a hexacomb paper structure layer or a corrugated paper structure layer for example. When exposed to heat, the cardboard will carbonize. On its own this disables the cardboard to prevent penetration of fire: the carbonized cardboard may be carried away from its position by air flows that are part of the fire. However, in combination the layer of fire resistant adhesive, supported by the iron or glass netting or fiber mat, will support the carbonizing cardboard and keep the airflows from the cardboard.

Use of an iron or glass netting or fiber mat, rather than a full metal foil layer, prevents problems due to bulging of the metal foil and keeps the weight of the wall low. The iron netting does not need to have a great thickness. A thickness between 0.2 and 1 to 2 millimeter may suffice. Preferably, the thickness of the layer of fire resistant adhesive is substantially the same as that of the iron netting, or larger. The presence of the layer of fire resistant adhesive with such a thickness provides support by the iron netting. The presence of the layer of fire resistant adhesive in the mazes a full surface resistance. The adhesive may effectively cover the paper sheet even if small openings are present, as long as no damaging air flows through the openings are possible. Some of the mazes of the iron netting may not need to be covered, if fire penetration is not a problem at their positions.

A fire resistant adhesive is an adhesive that adheres to paper and resists disintegration at least below a thousand degrees centigrade. Such fire resistant adhesives are commercially available. Preferably, a mineral powder based fire resistant adhesive is used, i.e. an adhesive wherein the adhesive function is realized by cohesion between mineral grains and their adhesion to paper. Such an adhesive comprises e.g. water and mineral such as silicon oxide grains, kaolinite grains etc. Fire resistant adhesives of this type are commercially available. The fire resistant adhesive may have a composition of water and/or water glass and/or mineral grains and/or glass bubbles, e.g. 70% water, 15% water glass and 15% mineral grains by weight. Cement may be suitable. Such a fire resistant adhesive becomes even more supportive when heated, due to sintering of the mineral grains. Water from such an adhesive, or water added to such an adhesive, provides for adhesion to the paper sheet, because it creates space between fibers of the paper within which the mineral grains of the fire resistant adhesive are able to penetrate. In addition the water may provide for cohesion between the mineral grains at least up to temperatures were the grains sinter to form a ceramic-type layer.

In an embodiment, the fiber mat is a glass fiber mat and the layer of fire resistant adhesive comprising glass grains admixed in the layer of fire resistant adhesive. This improves the adherence of the glass fibers to the adhesive by sintering when the wall is exposed to fire. The fiber mat may be a mat of chopped glass or carbon fibers or strands for example.

In an embodiment the cardboard of the layer of cellular cardboard may be drenched (soaked) in a mixture of water, water glass and mineral grains before use. Thus a layer of cellular cardboard may be realized with cardboard that comprises mineral grains and water glass impregnated in said cardboard. This reduces glowing when the cardboard is heated.

In an embodiment, the wall panel comprises inert grains that are inert in fire, such as perlite and/or vermiculite grains, and/or hollow glass bubbles, mineral wool, in the cell spaces. The inert grains slow heat penetration through the thickness of the cardboard, and its resulting carbonization further retarding the fire. Because the layer of fire resistant adhesive, supported by the iron or glass netting or fiber mat support the carbonizing cardboard and keep the airflows from the cardboard, this keeps the inert grains in place.

In an embodiment, the cell spaces may be air-filled, which means that no solid material such as inert grains is present in the cell spaces. It has been found that even without inert grains fire may be delayed sufficiently to ensure safety.

In an embodiment a further layer of cellular cardboard and inert grains in cell spaces of the further layer of cellular cardboard, and card board spacers connecting a surface of the further layer of cellular cardboard and a second surface of the layer of cellular cardboard, the first and second surface being opposite to one another. This retards the penetration of fire.

Protection against the penetration of fire from both sides of the wall may not be needed. But it may be provided by including the part of the cardboard layer that contains the cell spaces sandwiched between paper sheets on both sides of that part, with layers of fire resistant adhesive and iron netting embedded in the layers of fire resistant adhesive on both paper sheets.

In an embodiment an exterior paper layer may be present on the layer of fire resistant adhesive, to protect it from outside influences other than heat. For example, a water resistant layer may be used, wherein the exterior paper layer comprises a polymer layer on a paper layer.

The paper wall may be used as a structural element in a building, e.g. as a side wall or as a roof panel.

### BRIEF DESCRIPTION OF THE DRAWING

These and other objects and advantageous aspects will become apparent from a description of exemplary embodiment that refers to the following figures.

FIG. 1,2 show embodiments of a paper wall

FIG. 2a shows a side view of a corrugated paper wall

FIG. 3 shows another embodiment of a paper wall

FIG. 3a shows a side view of a paper wall

FIG. 4 shows a side view of a paper wall

FIG. 5 shows a cross-section of a building

FIG. 5a shows a V-groove in a paper wall

### DETAILED DESCRIPTION OF EXEMPLARY EMBODIMENTS

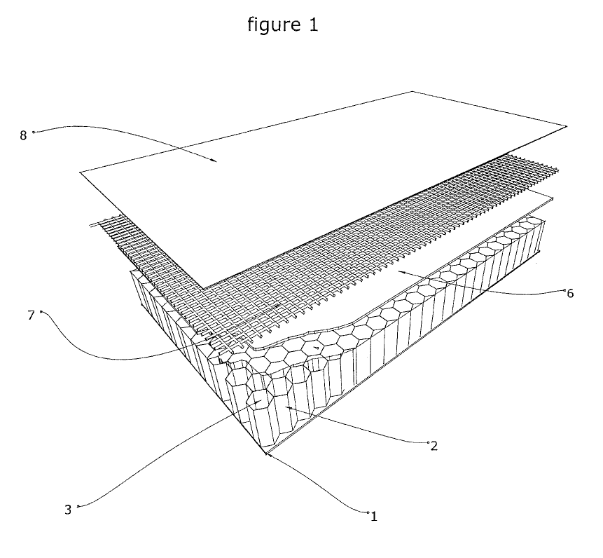

FIG. 1 shows a paper wall. The wall comprises a first exterior layer 1 and a second exterior layer 8. Furthermore, between the first exterior and second exterior layer 1, 8, the wall comprises a layer of cellular cardboard in the form of a hexacomb paper structure layer 2 and a fire resistant adhesive layer 6. In the final wall, a steel netting layer 7 is embedded in adhesive layer 6 (for the sake of illustration steel netting layer 7 is shown above adhesive layer 6, as it may be before steel netting layer 7 is pushed into adhesive layer 6).

Hexacomb paper structure layer 2 may be made of paper surrounding hexagonal cell spaces 3. Hexagonal cell spaces 3 extend perpendicularly to the surface of the wall (the surface of first and second exterior layer 1, 8), which will be called the top and bottom the surface of the hexacomb paper structure layer 2, without implying any orientation. Hexacomb paper structure layer 2 leaves cell spaces 3 open at the top and bottom surface. In an exemplary embodiment, hexacomb paper structure layer 2 may be 10 and 20 millimeter millimeter thick for example, or thicker.

In the illustrated embodiment hexagonal cell spaces 3 are filled with grains. Perlite grains and/or Vermiculite grains may be used, e.g. in the form of a mixture of Perlite grains 4 and/or Vermiculite grains 5. Instead of Perlite grains and Vermiculite grains other inert grains may be used, of material that does not melt or react with air a temperatures below 1000 degrees Celsius, such as sand grains. For example, here an in the other embodiments wherein Perlite grains and Vermiculite grains are disclosed, instead or in addition mineral wool and/or glass wool and/or hollow glass may be used (such as air filled glass bubbles, microspheres for example of 0.01 to 1 millimeter diameter). The use of such materials or Perlite grains and/or Vermiculite grains provides for a lighter wall. However, it has been found that even when hexagonal cell spaces 3 are not filled with grains, the fire retarding effect of the wall may be sufficient to delay fire for twenty minutes at seven hundred degrees Celsius, which is sufficient to comply with fire safety standards.

Fire resistant adhesive layer 6 is made of a fire resistant adhesive that adheres to paper and does not disintegrate at least below a thousand degrees Celsius. Such fire resistant adhesives are commercially available. A fire resistant adhesive like EMPE, available from the company Pull Rhenen may be used for example. As another example loam or loam clay may be used as fire resistant adhesive. Thus adhesive layer 6 may be a loam layer which will sinter when the wall is exposed to fire. In an embodiment wherein the iron netting is replaced by glass fibers or a glass netting, the loam layer preferably also comprises hollow glass to improve adhesion.

Preferably, a mineral powder based fire resistant adhesive is used, i.e. an adhesive wherein the adhesive function is realized by cohesion between mineral grains and their adhesion to paper. Such an adhesive comprises e.g. water and mineral such as silicon oxide grains, kaolinite grains etc. Fire resistant adhesives of this type are commercially available. Cement may be suitable. Such a fire resistant adhesive becomes even more supportive when heated, due to sintering of the mineral grains. Water from such an adhesive, or water added to such an adhesive, provides for adhesion to the paper sheet, because it creates space between fibers of the paper within which the mineral grains of the fire resistant adhesive are able to penetrate. In addition the water may provide for cohesion between the mineral grains at least up to temperatures were the grains sinter to form a ceramic-type layer. A ceramic-type material may be defined as any inorganic crystalline material, compounded of a metal and a non-metal. It is solid and inert. Sintering is the process of compacting and forming a solid mass of material, in the present case by heat without melting the material to the point of liquefaction.

A steel netting layer 7 may essentially consist of steel wire with a thickness between 0.2 and 2 millimeter, connected in a net (mesh) with openings with a greatest opening diameter of less than 50 and preferably less than 20 millimeter. The openings may have rectangular shapes with length and width below 50 and preferably below 20 millimeter (e.g. 10 or 15 millimeter) for example or hexagonal shapes with distances between parallel sides of the opening below 50 and preferably below 20 millimeter for example. Adhesive layer 6 is preferably substantially at least thick as the steel wire of steel netting layer 7 or slightly thicker. First and second exterior layer 1,8 may comprise paper layers. The exterior layer 8 that is provided in contact with adhesive layer 6 preferably comprises a paper layer impregnated with material from adhesive layer 6. An exterior layer comprising such an impregnated paper layer can easily be obtained by applying the paper layer on adhesive layer 7 when the latter has not yet dried. Preferably, the surface of the exterior layer that is exposed to the environment of the wall panel outside is the surface of such an impregnated paper layer. This prevents the formation of surface flames when the layer is heated, even if the paper carbonizes. Preferably exterior layer 1,8 also comprise a polymer (e.g. Testliner or Kraftliner). Although first and second exterior layer 1,8 are referred to as exterior layers in the structure shown in FIG. 1, it should be noted that other layers may be added on first and/or second exterior layer 1,8 outside the structure shown in FIG. 1. Instead of a steel netting, a netting of another type of iron or a glass netting may be used.

The wall may be manufactured by starting from a hexacomb paper structure layer 2 with cell spaces 3. In an embodiment, hexacomb paper structure layer 2 may be drenched in a mixture of water glass, an adhesive comprising mineral grains, like empe, and water, preferably with added mineral grains, before use (e.g. 80% water, 10% water glass and 10% mineral grains by weight). Thus, a cardboard comprising mineral grains and water glass impregnated in said cardboard may be formed. In a first step, the first exterior layer 1 is applied to the bottom surface of the hexacomb paper structure layer 2, e.g. by means of an adhesive. Preferably, the surface exterior layer 1 that contacts the bottom surface of hexacomb paper structure layer 2 is made of paper. This makes it easy to adhere exterior layer 1 and hexacomb paper structure layer 2.

In an optional second step, the open cell spaces 3 are filled with Perlite and/or Vermiculite grains 4,5, e.g. grains of one millimeter diameter. In a third step, adhesive layer 6 is applied on the top surface of hexacomb paper structure layer 2, e.g. with a thickness of at least steel netting layer 7. In a fourth step steel netting layer 7 is applied on top surface of adhesive layer 6. Steel netting layer 7 is pushed into adhesive layer 6. In a fifth step, second exterior layer 8 is applied on top of adhesive layer 6. Preferably, exterior layer 8 is applied to the paper layer on adhesive layer 7 when the latter has not yet dried. The application of second exterior layer 8 may be used to push steel netting layer 7 into adhesive layer 6. Alternatively, steel netting layer 7 may be pushed into adhesive layer 6 before second exterior layer 8 is applied. In another embodiment only a first part of adhesive layer 6 is applied in the third step and the fourth step is followed by a step wherein a second part of adhesive layer 6 is applied over steel netting layer 7, before the fifth step.

In use, the combination of adhesive layer 6 and steel netting 7 serves to provide a structure that (a) remains intact for a considerable time when exposed to fire and (b) protects the cellular cardboard from flames when it is located between the cellular cardboard and the flames. When a mineral grain based adhesive layer is used in adhesive layer 6, the grains may sinter to form a ceramic-like structure under the influence of fire, the grains being cemented to each other. But even before sintering adhesive layer 6, which adheres to the cardboard layer forms a closed layer. The steel netting layer 7 provides a support skeleton for adhesive layer 6, to prevent its disintegration into flakes. It has been found that a soldered steel netting layer 7, with a solder that may melt due to fire is able to perform this function. Alternatively a woven netting layer may be used. While intact, adhesive layer 6 resists penetration of flames to the cellular cardboard from the side of first exterior layer 1.

In the embodiment wherein perlite and/or vermiculite grains etc. are used in cell spaces 3 behind adhesive layer 6, the perlite and/or vermiculite grains etc. prevent rapid heating and glowing of hexacomb paper structure layer 2. With time, a local temperature gradient will arise over hexacomb paper structure layer 2 at the place where the adhesive layer 6 is exposed to flames, e.g. from 1000 degrees Celsius at the surface hexacomb paper structure layer 2 adjacent adhesive layer 6 to 200 degrees Celsius on the other surface of hexacomb paper structure layer 2. Such temperatures may cause part of hexacomb paper structure layer 2 to carbonize. But it has been found that the carbonized part of hexacomb paper structure layer 2 remains capable of holding the perlite and/or vermiculite grains etc. in place. This enables the wall to retain its structural function in a building and resist penetration of flames for considerable time.

In the embodiment wherein the hexacomb paper structure layer 2 has been drenched in a mixture of water glass and adhesive comprising mineral grains, like empe, water, preferably with added mineral grains, oxygen is substantially expelled from the paper and oxygen transport through the paper is substantially blocked. This prevents the heated paper from glowing, which has the effect that the structural support provided by the hexacomb paper structure layer 2 is better preserved when the outside of the wall is exposed to fire.

When the outer surface of exterior layer 8 is a paper layer impregnated with material from adhesive layer 7, the formation of flames at the surface is prevented.

In an embodiment a fiber mat layer may be used instead of steel netting layer 7. A glass fiber mat may be used for example, or a mat of another type of mineral fibers or of carbon fiber. The mat may contain chopped fibers or strands of glass, carbon etc. Like steel netting layer 7, the fiber mat layer is embedded in adhesive layer 6. Use of a fiber mat instead of an iron netting has the effect that such a fiber mat expands less with increasing temperature. The mat may be a prefabricated mat that is applied to the paper/cardboard structure, or it may be formed during manufacture of the wall by depositing chopped glass or carbon fibers or strands.

In an embodiment, adhesive layer 6 comprises glass grains (hollow glass e.g. glass beads with a diameter in a range of 0.01-1 millimeter). In an embodiment of the process of manufacturing this embodiment, and adhesive with added glass grains may be used. The adhesive with added grains may be applied on the top surface of hexacomb paper structure layer 2 in the third step. The glass grains improve adhesion of the glass fibers to adhesive layer 6 when the combination of adhesive layer 6 and the embedded fiber mat layer 70 exposed to heat.

In a further embodiment, both an embedded iron or glass netting and a fiber mat are used in place of the embedded iron netting alone.

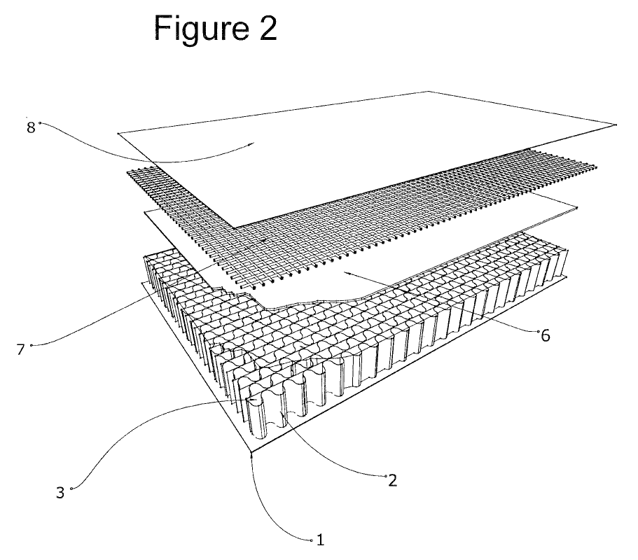

FIG. 2 shows a wall wherein the layer of cellular cardboard is a corrugated paper structure layer 2a instead of the hexacomb paper structure layer. A corrugated paper structure comprises one or more paper layers with an undulating surface, e.g. a surface with substantially a sine function cross-section, but other shapes such as saw tooth cross-section etc. may be used. The wall comprises a first exterior layer 1 and a second exterior layer 8, comprising a corrugated paper (e.g. cardboard) layer 2a and an adhesive layer 6 between the first exterior and second exterior layer. Corrugated paper structure layer 2a comprises cell spaces 3 surrounded by paper that extend perpendicularly to the surface of the wall. A steel netting layer 7 is embedded in adhesive layer 6.

FIG. 2a shows a cross-section of the wall of FIG. 2 in side view. A side view of a cross-section of the wall of FIG. 1 will be similar to this side view.

The wall of the embodiment of FIGS. 2, 2a may be manufactured using a similar process as that for manufacturing the wall of FIG. 1, but starting from a corrugated paper structure layer 2a with open cell spaces 3 extending perpendicularly to the surface of the wall, the cells spaces being open at the surface of the corrugated paper structure layer 2a. As for the embodiment of FIG. 1, a fiber mat layer may be used instead of iron netting layer 7. Similarly, corrugated paper structure layer 2a may be drenched in a mixture of water glass, adhesive comprising mineral grains, like empe, and water as in the embodiment of FIG. 1.

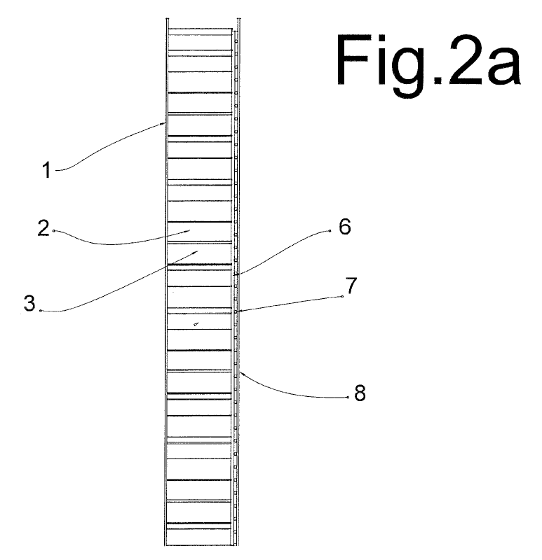

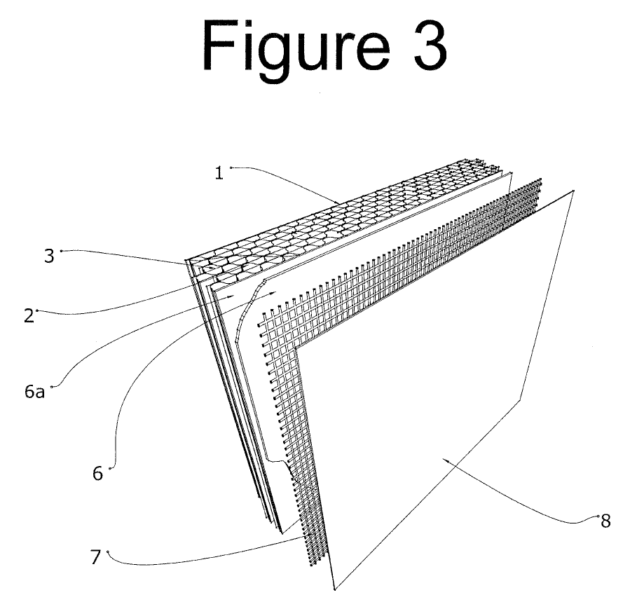

FIG. 3 shows an embodiment of a paper wall filled with perlite and/or vermiculite grains, which is similar to that of FIG. 2 except that the cell spaces of the layer of cellular cardboard formed by corrugated paper structure layer 2a extend in parallel with the surface of the wall. Optionally, an additional paper layer 6a is provided between corrugated paper structure layer 2a and adhesive layer 6. In this embodiment corrugated paper structure layer 2a has cell spaces that extend in parallel with the surface of the wall. As for the embodiment of FIG. 1, a fiber mat layer may be used instead of iron netting layer 7. In another embodiment, the perlite and/or vermiculite grains may be left out, using empty cell spaces.

The wall of FIG. 3 may be manufactured using a similar process as that for manufacturing the wall of FIG. 1, but starting from a corrugated paper structure layer 2a with open cell spaces 3 extending in parallel to the surface of the wall. Corrugated paper structure layer 2a is filled with Perlite and/or Vermiculite grains from the side of corrugated paper structure layer 2a. In an optional next step, additional paper layer 6a is applied on top of corrugated paper structure layer 2a, e.g. by means of adhesive.

Otherwise, the processing may be the same as for the earlier embodiments. Similarly, corrugated paper structure layer 2a may be drenched in a mixture of water glass, an adhesive comprising mineral grains, like empe, and water as in the embodiment of FIG. 1. The first exterior layer 1 may be applied to one surface of the corrugated paper structure layer 2a, e.g. by means of an adhesive. Adhesive layer 6 is applied on top of corrugated paper structure layer 2a or optional additional paper layer 6a, steel netting layer 7 is applied on top of adhesive layer 6 and second exterior layer 8 is applied on top of adhesive layer 6. During the process, steel netting layer 7 is pushed into adhesive layer 6. A similar process may be used for a further embodiment, wherein a hexacomb paper structure layer with cell spaces that extend in parallel with the surfaces of the hexacomb paper structure layer is used instead of hexacomb paper structure layer 2 with cell spaces perpendicular to the surfaces of the hexacomb paper structure layer.

Each of the embodiments enables the wall to resist penetration of flames from one side outside the surface of hexacomb paper structure layer 2 or corrugated paper structure layer 2a on which steel netting 7 is provided. The hexacomb paper structure layer 2 or corrugated paper structure layer 2a retains its structural function in a building for considerable time as described for the embodiment of FIG. 1. To enable resistance to penetration by flames from both sides steel nettings layers embedded in fire resistant adhesive layers may be provided on two opposite surfaces of the paper structure layer that may have spaces filled with Perlite and/or Vermiculite grains etc.

In other embodiments based on the preceding embodiments, an additional cellular cardboard layer may be provided on top of hexacomb paper structure layer 2 or corrugated paper structure layer 2a instead of second exterior layer 8 and optionally on second exterior layer 8. The additional cellular cardboard layer may be used to support the structural function of the wall. The additional cellular cardboard layer may have air filled cell spaces (not filled with Perlite and/or Vermiculite grains). The hexacomb paper structure layer 2 or corrugated paper structure layer 2a between the additional cellular cardboard layer and the steel netting layer 7 embedded in adhesive layer 6 protects the additional cellular cardboard layer from reaching excessive temperatures.

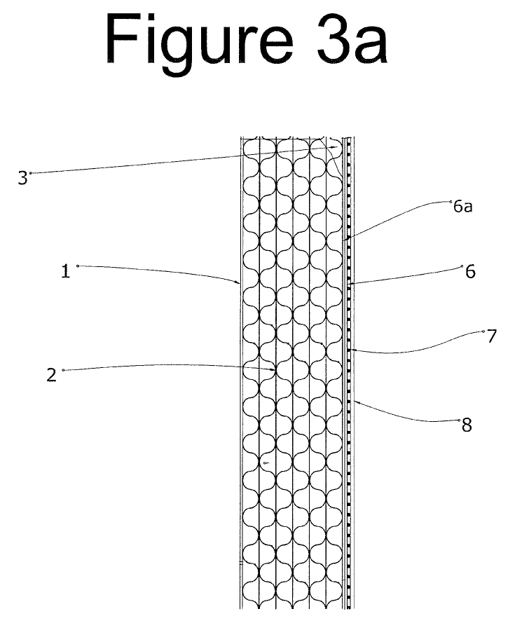

FIG. 4 shows an embodiment of a paper wall wherein paper structure layers 2a filled with perlite and/or vermiculite grains are provided on both opposite surfaces of an interior paper structure layer 9. By way of example, paper structure layers 2a in the form of corrugated paper structure layers 2a with cell spaces in parallel with the surfaces of paper structure layers 2a are shown, but other paper structure layers 2a may be used. By way of example, interior paper structure layer 9 has a hexacomb paper structure layer with cell spaces perpendicular to the surfaces, which increases structural strength, but other types of paper structure may be used in interior paper structure layer 9. Preferably, interior paper structure layer 9 has air filled spaces (not filled with Perlite and/or Vermiculite grains), in contrast to the paper structure layers 2a on its opposite surfaces, which have cell spaces filled with Perlite and/or Vermiculite grains. Adhesive layers 6 and steel wire nettings 7 embedded in adhesive layers 6 are provided on paper structure layers 2a. Exterior layers 8 are provided on adhesive layers 6 and embedded steel wire nettings 7. Thus a sandwich is provided with exterior layers 8 on the outside and interior paper structure layer 9 in the middle, with adhesive layers 6 with embedded steel wire nettings 7 and perlite and/or vermiculite filled paper structure layers 2a successively between exterior layers 8 and interior paper structure layer 9 on both surfaces of interior paper structure layer 9. Instead of steel wire nettings 7 embedded fiber mats (e.g. glass fiber mats such as mats containing chopped fibers or strands may be used on one or both sides. Preferably, exterior layers 8 both comprise a paper layer impregnated with material from adhesive layer 6. Preferably, the surfaces of exterior layers 8 that are exposed to the environment of the wall panel outside is the surface of such an impregnated paper layer. This prevents the formation of surface flames when the layer is heated, even if the paper carbonizes.

This embodiment of the paper wall enables the wall to resist penetration of flames from both sides. When exposed to high temperatures the powder in the adhesive layer that is exposed to the fire forms a ceramic-type layer, which is protected against flaking by the iron netting embedded in the adhesive layer. Adhesive layer 6 prevents penetration of the flames to the adjacent perlite and/or vermiculite filled paper structure layer, so that part of the paper structure layer at most carbonizes, keeping the perlite and/or vermiculite grains in place and an excessive temperature rise is delayed.

In an embodiment wherein cardboard spacers may be provided between structure layers 2a. The spacers connect structure layers 2a through part of the space between structure layers 2a in the interior of the wall. The spacers may be cardboard tubes, adhered to structure layers 2a. Use of spacers increases the duration of time during which the wall can prevent fire from reaching through the wall. A spatially periodic array of spacers may be used.

In an embodiment the spacers are drenched in a mixture of water glass and water, preferably with added mineral grains before use (e.g. 80% water, 10% water glass and 10% mineral grains by weight. The mineral grains may be partly provided as an adhesive composition containing mineral grains like empe (e.g. 10% empe adhesive).

Although embodiments with an embedded iron netting layer or an embedded fiber mat layer near the outside surface of the wall and with iron netting layers or fiber mat layers near the outside surfaces of the wall have been described, it should be noted that in addition at least one further internal embedded iron netting layer or embedded glass fiber mat layer may be used, separated from the outside surfaces of the wall by cellular cardboard layers. This may be used to increase the retardation of fire penetration.

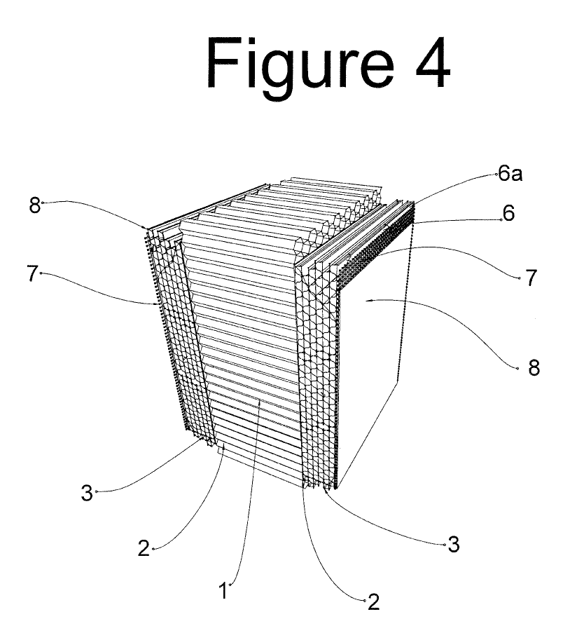

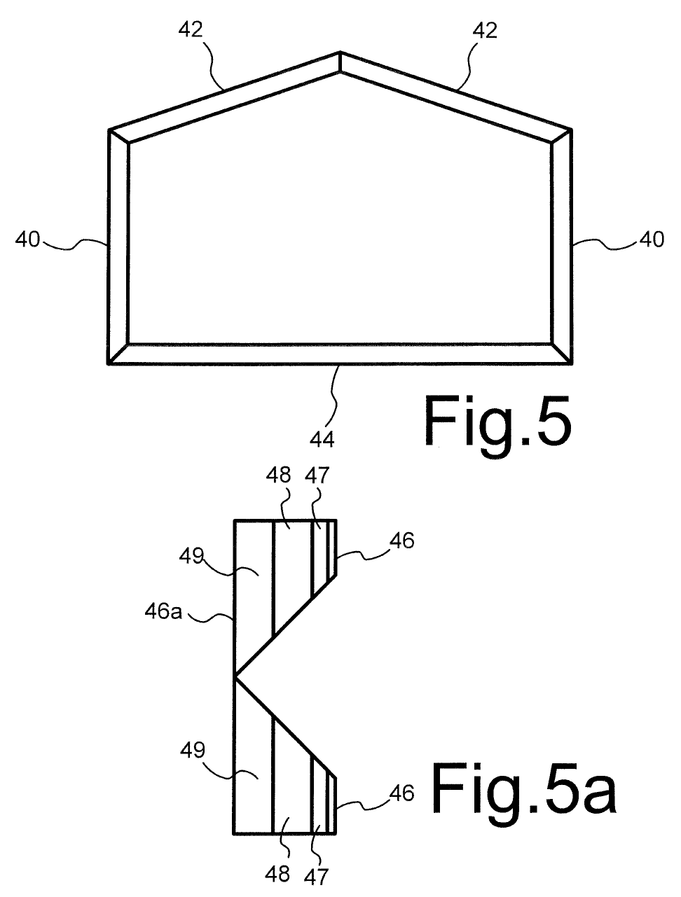

FIG. 5 shows a cross-section of an exemplary building formed from paper walls of the previous embodiments. Herein the paper walls form structural elements of the building, i.e. elements that are indispensable to prevent the building from collapse, wherein the combination of the cellular cardboard structure, the adhesive layer and the netting is use to perform the function of a wall that prevent the building from collapse, without requiring further structural elements. The building has side panels 40, roof panels 42 and a floor panel 44. Each of the side panels 40, roof panels 42 and floor panel 44 may be a paper wall according to any one of the previous embodiments. In an embodiment two or more of side panels 40, roof panels 42 and floor panel 44 may be formed from a single paper wall according to any one of the previous embodiments, which is bent between successive ones of the side panels 40, roof panels 42 and floor panel 44. Preferably the iron netting embedded in the adhesive layer is provided at least on the inside of the building, to protect against fire inside the building. An additional iron netting embedded in an adhesive layer may be provided on the outside.

FIG. 5a (not to scale) shows an embodiment of the paper wall panel that facilitates bending. A wall panel comprising exterior layer 46, a first layer 47 on top of exterior layer 46, the first layer comprising adhesive and an iron netting embedded in the adhesive, a layer of cellular cardboard 48 on top of the first layer 47, layer of cellular cardboard 48 having cell spaces, which are preferably filled with inert grains, such as perlite and/or vermiculite grains and a paper structure layer 49 on top of layer of cellular cardboard 48. The cell spaces of paper structure layer 49 are air filled, substantially without inert grains. In another embodiment the layer of cellular cardboard 48 may have having air filled cell spaces as well, without inert grains. A paper layer 46a, preferably 8 comprising a polymer as reinforcement (e.g. Testliner or Kraftliner) is provided on paper structure layer 49. Optionally a further layer of cellular cardboard (not shown) having cell spaces filled with inert grains may be provided between paper structure layer 49 and paper layer 46a, with a second layer (not shown) comprising adhesive and an iron netting embedded in adhesive between the further layer of cellular cardboard and paper layer 46a. Also optionally, further paper layers may be provided e.g. between layer of cellular cardboard 48 and paper structure layer 49, between paper structure layer 49 and the further layer of cellular cardboard, or on top of the second layer.

Herein a V groove has been cut in the paper wall panel, through all layers but paper layer 46a. When the building is assembled, the parts of the paper wall adjacent the V-groove are rotated relative to each other to close the V-groove. One or more clamping metal bands along the periphery of the building, each enclosing side panels 40, roof panels 42 and floor panel 44 in a cross-section of the building as shown in FIG. 4 may be used to keep the building erect by forcing the V-grooves at bends in the cross-section to remain in closed positions.

1. A wall panel comprising
a layer of cellular cardboard, comprising cell spaces surrounded by cardboard, the layer of cellular cardboard comprising a paper sheet on a first surface of the layer of cellular cardboard;
a layer of fire resistant adhesive on the paper sheet;
a layer of iron or glass netting and/or a fiber mat embedded in the layer of fire resistant adhesive, the fire resistant adhesive covering the paper sheet in mazes of the iron or glass netting when the layer of iron or glass netting is present and the fiber mat layer being impregnated with the fire resistant adhesive when the layer of the fiber mat is present.

2. The wall panel according to claim 1, comprising the fiber mat embedded in the layer of fire resistant adhesive.

3. The wall panel according to claim 2, wherein the fiber mat is a glass fiber mat, the layer of fire resistant adhesive comprising glass grains admixed in the layer of fire resistant adhesive.

4. The wall panel according to claim 1, wherein the cardboard in said layer of cellular cardboard comprises mineral grains and water glass impregnated in said cardboard.

5. The wall panel according to claim 1, comprising inert grains that are inert in fire in the cell spaces.

6. The wall panel according to claim 5, comprising
a further layer of cellular cardboard and inert grains in cell spaces of the further layer of cellular cardboard, and
card board spacers connecting a surface of the further layer of cellular cardboard and a second surface of the layer of cellular cardboard, the first and second surface being opposite to one another.

7. The wall panel according to claim 1, wherein the cell spaces are air-filled.

8. The wall panel according to claim 1, wherein the layer of cellular cardboard comprises a further paper sheet on a second surface of the layer of cellular cardboard, the cell spaces being located between the paper sheet and the further paper sheet, the wall panel comprising a further layer of fire resistant adhesive on the further paper sheet, and a further layer of iron or glass netting or a fiber mat embedded in the further layer of fire resistant adhesive.

9. The wall panel according to claim 1, wherein the fire resistant adhesive is mineral powder based adhesive.

10. The wall panel according to claim 1, comprising the layer of iron or glass netting wherein the layer of adhesive has a thickness of at least a thickness of the iron or glass netting.

11. The wall panel according to claim 1, comprising an exterior layer on the layer of fire resistant adhesive, the layer of fire resistant adhesive lying between the exterior layer and the layer of cellular cardboard, the exterior layer comprising a paper layer impregnated with material from the adhesive layer.

12. The wall panel according to claim 11, wherein the impregnated paper layer forms an exposed surface of the wall panel.

13. The wall panel according to claim 11, wherein the exterior paper layer comprises a polymer.

14. The wall panel according to claim 1, wherein the layer of cellular cardboard is a hexacomb paper structure layer.

15. The wall panel according to claim 1, wherein the layer of cellular cardboard is a corrugated paper structure layer.

16. The wall panel according to claim 1, comprising an exterior paper layer on said layer of fire resistant adhesive, said layer of fire resistant adhesive lying between the exterior paper layer and the layer of cellular cardboard.

17. A building comprising the wall panel according to claim 1 as a structural elements of the building.

18. A method of constructing a wall panel, comprising
applying a layer of fire resistant adhesive on a layer of cellular cardboard;
embedding an iron or glass netting or a fiber mat in the layer of fire resistant adhesive.

19. The method according to claim 18, wherein the fiber mat comprises glass fibers embedded in the layer of fire resistant adhesive, the fiber mat being a glass fiber mat, the layer of fire resistant adhesive being applied admixed with glass grains.

20. The method according to claim 18, wherein the a layer of cellular cardboard is drenched in a mixture of water, water glass and an adhesive comprising mineral grains.

21. The method according to claim 18, wherein the layer of cellular cardboard has a paper layer on top of the layer of cellular cardboard, the layer of fire resistant adhesive on a layer of cellular cardboard being applied on said paper layer.

22. The method according to claim 18, wherein the fire resistant adhesive is mineral powder based adhesive.

23. The method according to claim 18, wherein the layer of adhesive is applied with a thickness of at least a thickness of the iron or glass netting when the iron or glass netting is used.

24. The method according to claim 18, comprising applying an exterior layer, comprising a paper layer, on the layer of fire resistant adhesive, when the layer of fire resistant adhesive has not yet dried, so that the fire resistant adhesive impregnates the paper layer comprised in the exterior layer.

25. The method according to claim 18, the method comprising filling cell spaces of the layer of cellular cardboard with inert grains that are inert in fire or performing said step of applying the layer of fire resistant adhesive using said layer of cellular cardboard with cell spaces filled with the inert grains that are inert in fire.
